(19) United States
(12) Patent Application Publication
(10) Pub. No.: US 2016/0264165 A1
(43) Pub. Date: Sep. 15, 2016

(54) SECUREMENT SYSTEM

(71) Applicant: Janice Stokes, Ocala, FL (US)

(72) Inventor: Janice Stokes, Ocala, FL (US)

(21) Appl. No.: 15/066,926

(22) Filed: Mar. 10, 2016

Related U.S. Application Data
(60) Provisional application No. 62/131,660, filed on Mar. 11, 2015.

(51) Int. Cl. B62B 5/00

(52) U.S. Cl. CPC B62B 5/0013

(57) ABSTRACT

A cover configured to be detachably coupled to a product support container includes a flexible body, a an edge portion disposed about a periphery of the flexible body, and a plurality of coupling members secured directly or indirectly to the periphery and configured to detachably couple the flexible body to a product support container having an opening such that the flexible body spans across at least a portion of the opening to define a protected volume. The cover may include an accessory pocket having an accessible opening, where the accessory pocket is disposed entirely outside the protected volume when the cover is in use. The cover may also include a storage pouch secured directly or indirectly to the edge portion and configured to receive and store the flexible body.

### CROSS-REFERENCE TO RELATED APPLICATIONS

This application claims priority to co-pending U.S. Provisional Patent Application No. 62/131,660 filed on Mar. 11, 2015, the entire content of which is incorporated herein by reference.

### SUMMARY OF THE INVENTION

In one embodiment, a cover includes a flexible body, an edge portion disposed about at least a portion of the periphery of the flexible body, a plurality of coupling members secured directly or indirectly to the edge portion and configured to detachably couple the flexible body to a compartment having an opening such that the flexible body and the compartment define a protected volume therebetween, and a storage pouch secured directly or indirectly to the edge portion and configured to receive and store the flexible body.

In another embodiment, a cover includes a flexible body having a periphery, a plurality of coupling members secured directly or indirectly to the periphery and configured to detachably couple the flexible body to a product support container having an opening such that the flexible body spans across at least a portion of the opening to define a protected volume, and an accessory pocket having an accessible opening, the accessory pocket disposed entirely outside the protected volume when the cover is in use.

In another embodiment, a system for defining a protected volume in a shopping cart includes a shopping cart with a compartment having an opening, and a cover including a flexible body, an edge portion disposed about at least a portion of the periphery of the flexible body and coupled to the compartment such that the flexible body and the compartment define a protected volume therebetween, and an accessory pocket having an accessible opening, the accessory pocket disposed entirely outside the protected volume when the cover is in use.

Other features and aspects of the disclosure will become apparent by consideration of the following detailed description and accompanying drawings.

### BRIEF DESCRIPTION OF THE DRAWINGS

FIG. 1 is a perspective view of an embodiment of a cover.

FIG. 2 is a plan view of the embodiment of the cover shown in FIG. 1.

FIG. 3 is a perspective view of an accessory pocket of the cover shown in FIG. 1.

FIG. 4 is a perspective view of another embodiment of a cover.

FIG. 5 is a plan view of the embodiment of the cover shown in FIG. 4.

FIG. 6 is a perspective view of the cover of FIG. 1 in use with a shopping cart.

FIG. 7 is a front view illustrating an accessory pocket of the cover.

FIG. 8 is a perspective view of a cover following a first step of a storage procedure.

FIG. 9 is a perspective view of the cover of FIG. 8 following a second step of the storage procedure.

FIG. 10 is a perspective view of the cover of FIG. 9 following a third step of the storage procedure.

FIG. 11 is a perspective view of the cover of FIG. 10 following a fourth step of the storage procedure.

FIG. 12 is a perspective view of the cover of FIG. 11 following a fifth step of the storage procedure.

Before any embodiments of the disclosure are explained in detail, it is to be understood that the disclosure is not limited in its application to the details of construction and the arrangement of components set forth in the following description or illustrated in the following drawings. The disclosure is capable of supporting other embodiments and of being practiced or of being carried out in various ways. Also, it is to be understood that the phraseology and terminology used herein is for the purpose of description and should not be regarded as limiting.

### DETAILED DESCRIPTION

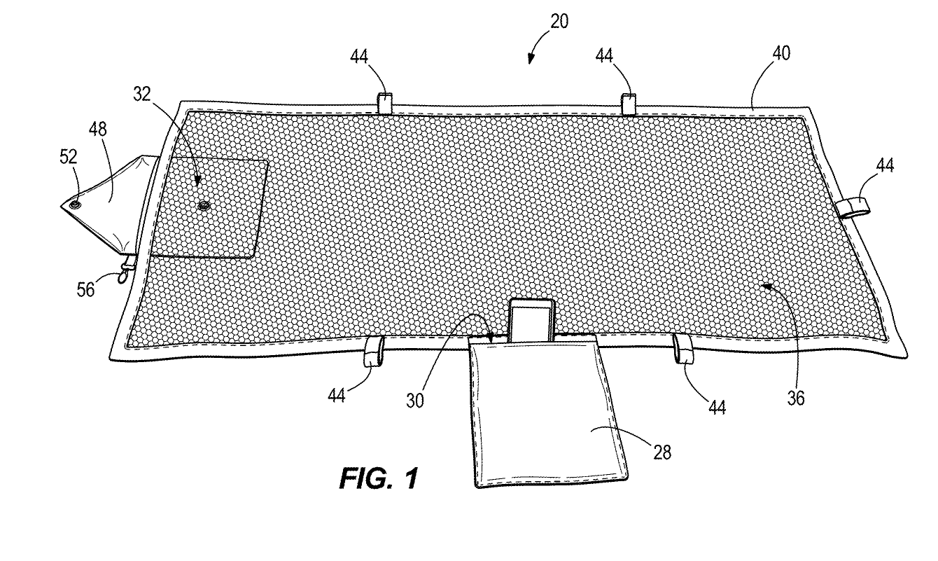

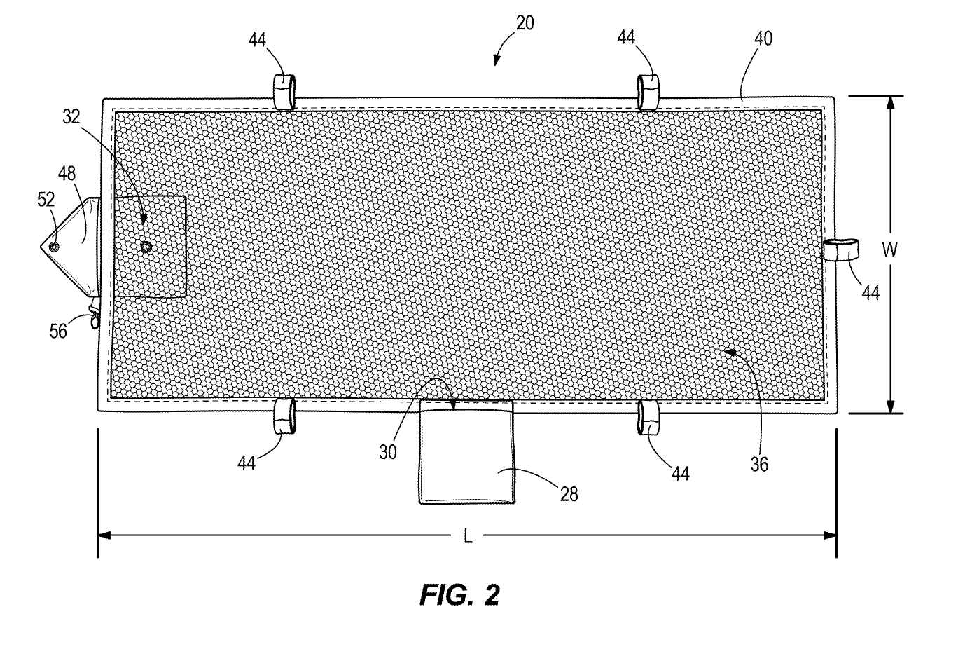

FIGS. 1 and 2 illustrate a detachable cover 20 according to one embodiment. The cover 20 includes a body 36 defining an interior portion and an edge portion 40 generally surrounding the perimeter of the body 36. The body 36 is made of a flexible material that permits the body 36 to deform and adapt to the contours of any structure over which it is disposed. In the embodiment shown, this material is a mesh fabric, but in other embodiments can be a soft plastic (e.g., transparent plastic), synthetic or natural fabric, or any suitable flexible material.

The edge portion 40 is constructed of a bias binding tape, although any other flexible and durable material like soft plastic, or synthetic or natural fabrics suitable to form an edge of a flexible body material may be used. The edge portion 40 also includes a plurality of coupling members 44. In the illustrated embodiment, the coupling members 44 are shown as hook and loop tabs (e.g., Velcro®) that are disposed in a plurality of locations along the edge portion 40. The coupling members 44 may also be hooks, clips, ties, elastic bands, snaps, or other suitable fastening member at any location along the edge portion 40 for securing the cover 20 to a supporting or retaining surface.

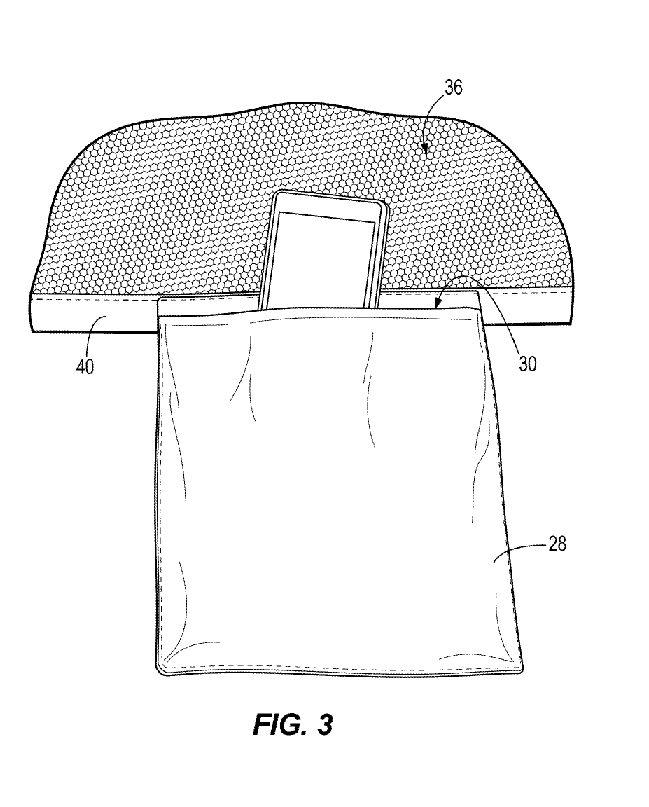

Referring also to FIG. 3, an accessory pocket 28 is coupled to the edge portion 40 and has an opening 30. The pocket 28 defines a volume for a user to place a small object (e.g., cell phone, wallet, shopping list) for temporary storage and easy accessibility during use of the cover 20. The accessory pocket 28 can be located at any point along the edge 40 and is constructed of a solid, opaque fabric, though in alternative embodiments the accessory pocket 28 may be a mesh or of another non-opaque construction.

With continued reference to FIGS. 1 and 2, the cover 20 further includes a storage pouch 32 centrally positioned along one side of the edge portion 40 and having a closure flap 48 and self-attachment feature 52 (e.g., hook and loop, snap closures, buttoned closure, hook, etc.) to form an enclosed region to hold the cover 20 in a folded or other compact configuration when the cover 20 is not in use. The storage pouch 32 may further include an external clasp 56 for use in storing or transporting the cover 20 while the cover is stored within the storage pouch 32. Although the storage pouch 32 is shown centrally positioned along one side of the edge portion 40, in other embodiments the storage pouch 32 may be located offset from the center of the edge portion 40.

In the construction illustrated in FIG. 2, the cover 20 has a total length of about 40 inches and a total width of about 20 inches. The edge portion 40 has a width W of approximately 1 inch. The accessory pocket 28 is approximately 6.5 inches by 7.5 inches and the storage pouch 32 is approximately 6 inches by 7 inches, with the self-attachment feature 52 in the form of a hook and loop closure (e.g., Velcro®).

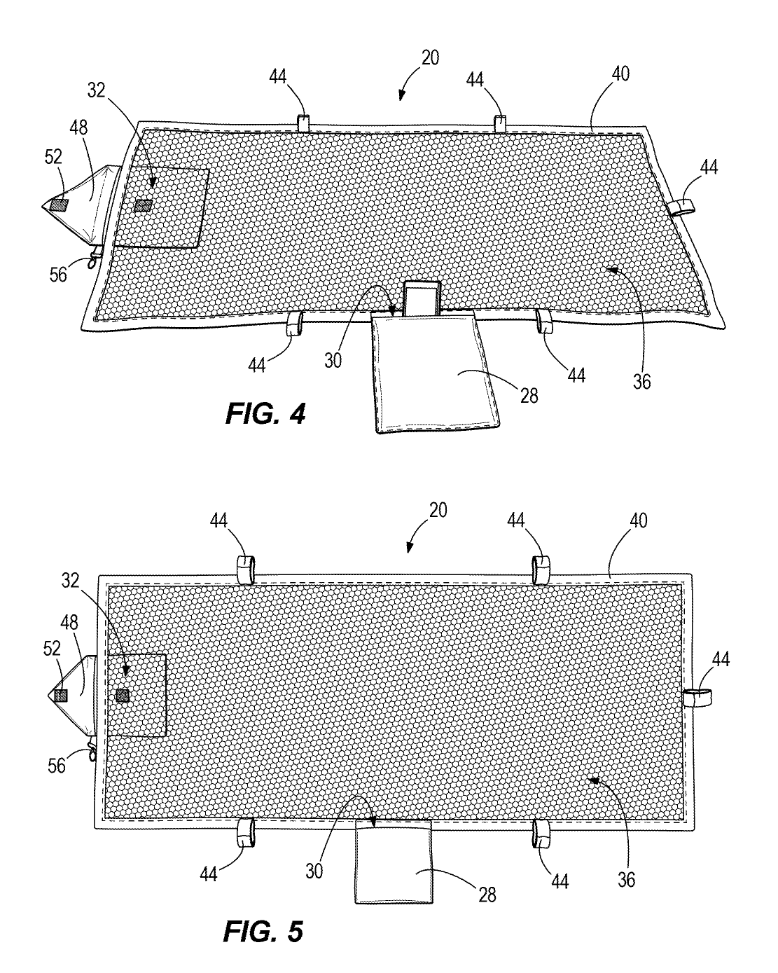

In a second construction, illustrated in FIGS. 4 and 5, the cover 20 is generally of the same configuration as that of FIGS. 1 and 2, but the edge portion 40 has a width W less than that shown in FIGS. 1 and 2 (i.e., of approximately 0.5 inches). In addition, the self-attachment feature 52 is in the form of a snap in lieu of a hook and loop closure.

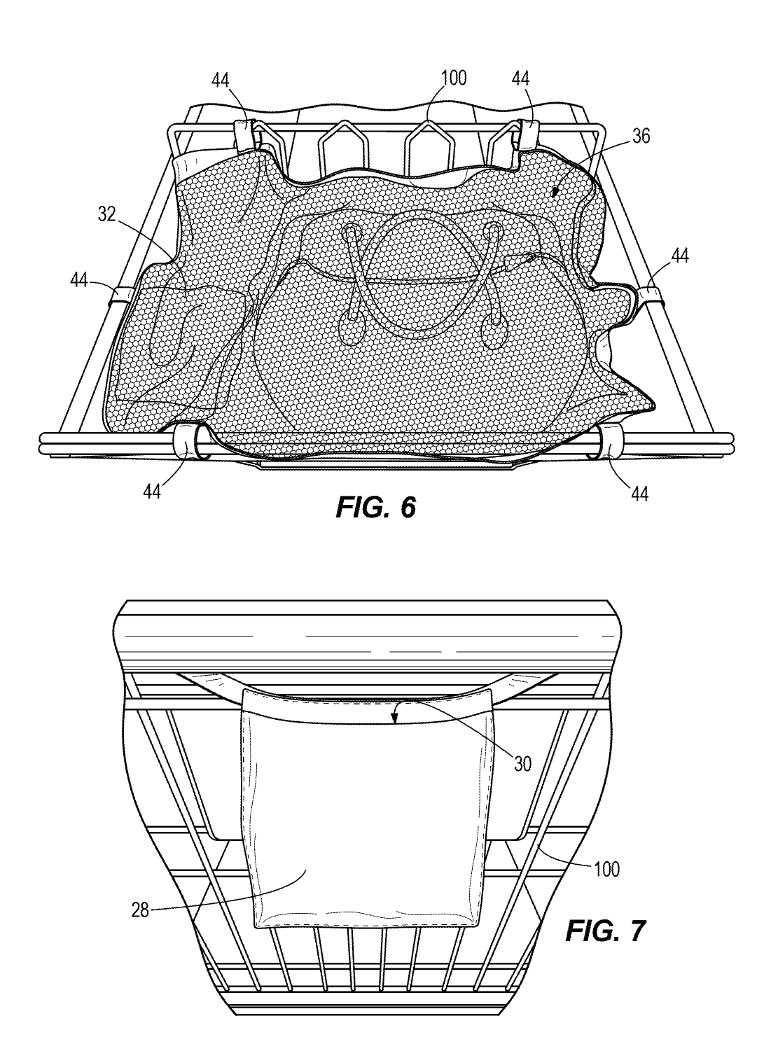

FIGS. 6 and 7 illustrate an exemplary uses of the cover 20 attached to a product support container, compartment, or shopping cart 100 and protecting an item, such as a purse. In this use, one or more of the coupling members 44 are looped around a respective retaining feature on the shopping cart 100 (e.g., the baby seat or a rail member) as shown to couple the cover 20 to the cart 100 and define an enclosed or protected volume 24 containing the item. The body 36, being flexible, deforms to span across at least a portion of the opening of the container or compartment, or the associated portion of the shopping cart 100 to fully cover the item disposed beneath it. The coupling of the cover 20 to a portion of the shopping cart 100 and over the item serves to hinder access to the item by a passerby. As shown best in FIG. 7, the accessory pocket 28 remains exterior to the volume defined by the cover 20 and thus accessible to the user.

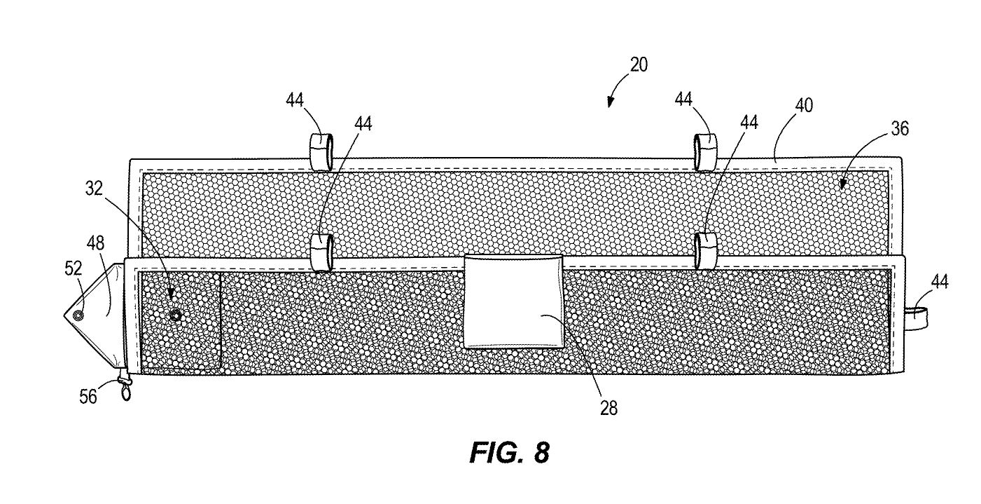

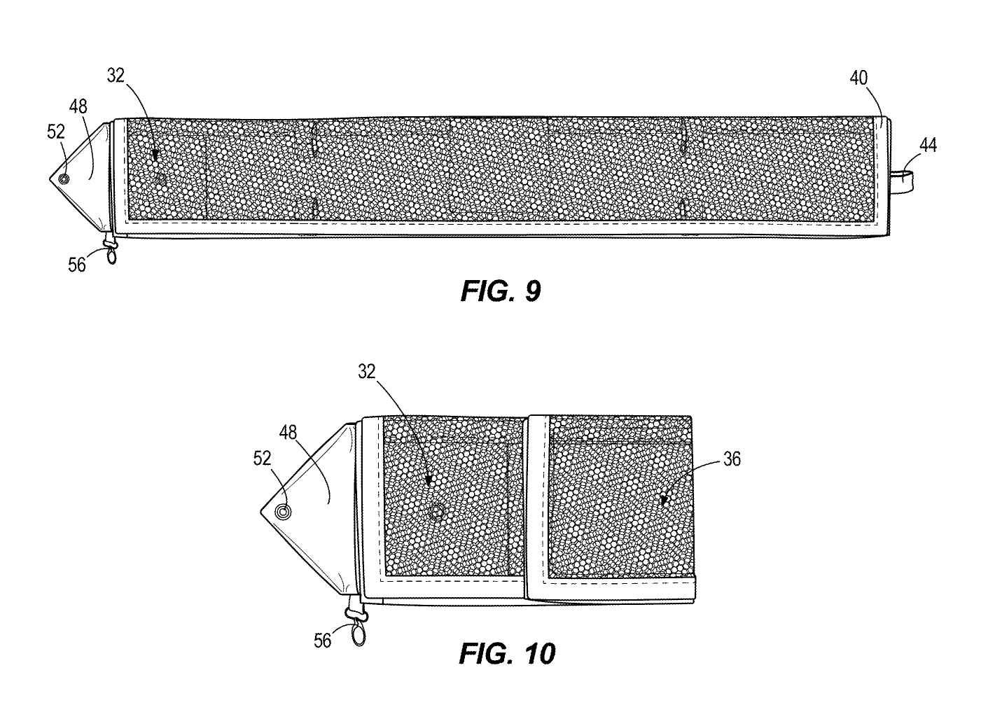

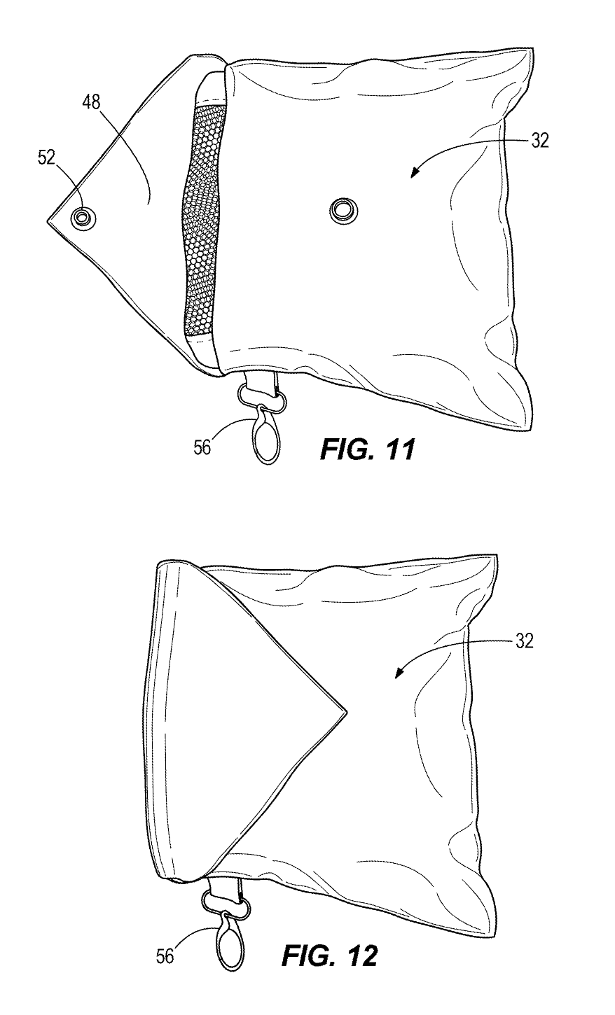

When the cover 20 is not in use, a user may decouple it from the shopping cart 100 and store it in the attached storage pouch 32. Referring now to FIGS. 8-12, a procedure for storing the cover 20 in the storage pouch 32 is shown according to one construction. In a first storage step, a first outer third of the expanded area of the body 36 is folded onto the middle third parallel to the length of the cover 20 (FIG. 8). The second outer third of the body 36 is then folded onto the middle third parallel to the first fold (FIG. 9). The cover is then folded parallel to the width of the cover 20, or alternatively rolled, toward the closure flap 48 (FIG. 10), after which it is placed into the storage pouch 32 (FIG. 11). FIG. 12 shows the closure flap 48 secured using the attachment feature 52 to enclose the body 36 within the storage pouch 32.

Various features of the disclosure are set forth in the following claims.

What is claimed is:

1. A cover comprising:
a flexible body;
an edge portion disposed about at least a portion of the periphery of the flexible body;
a plurality of coupling members secured directly or indirectly to the edge portion and configured to detachably couple the flexible body to a compartment having an opening such that the flexible body and the compartment define a protected volume therebetween; and
a storage pouch secured directly or indirectly to the edge portion and configured to receive and store the flexible body.

2. The cover according to claim 1, wherein the flexible body is constructed from a mesh material.

3. The cover according to claim 1, wherein the flexible body is constructed from a transparent plastic.

4. The cover according to claim 1, further including an accessory pocket secured directly or indirectly to the edge portion, the accessory pocket disposed outside the protected volume when the cover is in use.

5. The cover according to claim 1, wherein the coupling members are at least one selected from the group including a hook and loop tab, a clip, a tie, a cord, elastic bands, and a snap connector.

6. A cover comprising:
a flexible body having a periphery;
a plurality of coupling members secured directly or indirectly to the periphery and configured to detachably couple the flexible body to a product support container having an opening such that the flexible body spans across at least a portion of the opening to define a protected volume; and
an accessory pocket having an accessible opening, the accessory pocket disposed entirely outside the protected volume when the cover is in use.

7. The cover according to claim 6, wherein the flexible body is constructed from a mesh material.

8. The cover according to claim 6, further including a storage pouch secured directly or indirectly to the edge portion and configured to receive and store the flexible body.

9. The cover according to claim 6, wherein the edge portion is constructed from a binding tape.

10. The cover according to claim 6, wherein the coupling members are at least one of a group including a hook and loop tab, a clip, a tie, a cord, elastic bands, and a snap connector.

11. The cover according to claim 6, wherein the accessory pocket is constructed from an opaque material such that an observer cannot see the contents of the accessory pocket.

12. A system for defining a protected volume in a shopping cart, the system comprising:
a shopping cart with a compartment having an opening; and
a cover including
a flexible body;
an edge portion disposed about at least a portion of the periphery of the flexible body and coupled to the compartment such that the flexible body and the compartment define a protected volume therebetween; and
an accessory pocket having an accessible opening, the accessory pocket disposed entirely outside the protected volume when the cover is in use.

13. The system of claim 12, wherein the flexible body is constructed from a mesh material.

14. The system of claim 12, wherein the coupling members are at least one of a group including a hook and loop tab, a clip, a tie, a cord, elastic bands, and a snap connector.

15. The system of claim 12, wherein the cover further includes a storage pouch secured directly or indirectly to the edge portion and configured to receive and store the flexible body.

16. The system of claim 12, wherein the accessory pocket is constructed from an opaque material such that an observer cannot see the contents of the accessory pocket.

17. The system of claim 12, wherein the coupling members are spaced at regular intervals along the edge portion.
